(19) United States
(12) Patent Application Publication
(10) Pub. No.: US 2014/0304013 A1
(43) Pub. Date: Oct. 9, 2014

(54) Airport Experience

(71) Applicant: Barclays Bank PLC, London (GB)

(72) Inventors: Matthew Massaus, Villanova, PA (US); Catherine Nieburg, Avondale, PA (US); Lisa Marie Herberger, Westerville, OH (US); Megan Basilio, Kennett Square, PA (US); Kelly Hixon Furman, Wilmington, DE (US); Peggy Maher Doherty, New York, NY (US)

(21) Appl. No.: 14/244,574

(22) Filed: Apr. 3, 2014

Related U.S. Application Data
(60) Provisional application No. 61/807,937, filed on Apr. 3, 2013.
(60) Provisional application No. 61/807,931, filed on Apr. 3, 2013.
(60) Provisional application No. 61/807,925, filed on Apr. 3, 2013.

(51) Int. Cl. G06Q 40/02; G06Q 10/02; G06Q 50/14

(52) U.S. Cl. CPC G06Q 40/025; G06Q 10/02; G06Q 50/14
USPC 705/5

(57) ABSTRACT

A system for credit issuance provides for fully automated credit evaluation and card issuing integrated with travel provider ticketing and reservations. The system includes a travel provider processing system under control of travel provider, a credit card authentication and issuance system working under control of a credit card issue in conjunction with a payment transaction service in a banking system, and a plurality of travelers wishing take advantage of flights, promotions and convenient credit card issuance. Once a traveler books a ticket, information collected during the ticketing process is shared by a travel provider with a credit card issuer. With this information a determination is made by the credit card issuer that the traveler is eligible to receive an offer for a credit card.

### CROSS-REFERENCE TO RELATED APPLICATIONS

This application claims the benefit of U.S. Provisional Patent application Ser. No. 61/807,937, entitled “Airport Experience,” filed on Apr. 3, 2013; U.S. Provisional Patent application Ser. No. 61/807,925, entitled “Airport Experience,” filed on Apr. 3, 2013; and U.S. Provisional Patent application Ser. No. 61/807,931, entitled “Airport Experience,” filed on Apr. 3, 2013

### BACKGROUND OF THE INVENTION

1. Field of the Invention

This invention pertains to computerized information management and processing systems generally, and more particularly to a method and system for automatically evaluating the credit of a potential borrower and delivering a credit instrument to the borrower in an expedited manner.

2. Description of the Background Art

When a travel provider passenger travels they wish the travel experience to be pleasurable. Card issuers and travel provider partners provide various benefits to travelers in exchange for the traveler applying for and using a borrowing instrument such as a credit card. In exchange for the traveler requesting a card the card issuer or travel provider partner provides the borrower with discounted baggage costs, club passes, priority boarding and the like.

When an airline ticket is purchased, a traveler shares information with the travel provider and this shared information can then be used by a card issuing partner to determine credit worthiness of a traveler to receive a credit card offer and a grouping of instantaneous rewards or benefits that are associated with the card.

Therefore, a need exists for a fully integrated credit evaluation and issuing system which provides quick approval and delivery of a credit card to a traveler along with various travel benefits.

### BRIEF SUMMARY OF THE INVENTION

It is, therefore, an object of the present invention to provide a system for credit issuance. The system provides for fully automated credit evaluation and card issuing integrated with travel provider ticketing and reservations. The system includes a travel provider processing system under control of a travel provider, a credit card authentication and issuance system working under control of a credit card issuer in conjunction with a payment transaction service in a banking system, and a plurality of travelers wishing to take advantage of flights, promotions and convenient credit card issuance. Once a traveler books a ticket, information collected during the ticketing process is shared by a travel provider with a credit card issuer. With this information a determination is made by the credit card issuer that the traveler is eligible to receive an offer for a credit card.

It is also an object of the present invention to provide a system for credit issuance wherein the traveler receives an email reminder from the travel provider processing system to check-in for a flight, and the email is accompanied by a pre-approved offer for a credit card issued by the credit card issuer.

It is another object of the present invention to provide a system for credit issuance wherein the traveler is provided a pre-approved offer at an airport terminal for a credit card issued by the credit card issuer.

It is a further object of the present invention to provide a system for credit issuance wherein the traveler is provided a pre-approved offer on an aircraft for a credit card issued by the credit card issuer.

It is also an object of the present invention to provide a system for credit issuance wherein the travel provider processing system includes a travel provider reservation system composed of travel provider schedules, passenger reservations and ticket records maintained in a travel provider database.

It is another object of the present invention to provide a system for credit issuance wherein passenger name records are maintained in the travel provider database.

It is a further object of the present invention to provide a system for credit issuance wherein the credit card approval [A1] and issuance system includes an authentication system, a payment scheme and the credit card issuer all connected via a data network.

It is also an object of the present invention to provide a system for credit issuance wherein the authentication system includes a registration module for processing registration of travelers to ultimately issue credit cards.

It is another object of the present invention to provide a system for credit issuance offering a computer integrated credit evaluation and card issuance system.

It is a further object of the present invention to provide a system for credit issuance offering a fully automated computer-based system for evaluating credit and issuing a credit card.

It is also an object of the present invention to provide a system for credit issuance for approving a borrower for a credit card and then issuing the card almost instantaneously or in an expedited manner.

It is another object of the present invention to provide a system for credit issuance which improves accuracy and speed in credit evaluation and card issuance.

It is a further object of the present invention to provide a system for credit issuance which can reduce the amount of human handling of information and provide an incentive for borrowers to request a credit card from an issuer.

It is an object of the invention to provide a method for credit issuance providing for automated credit evaluation and for card issuing integrated with travel provider ticketing and reservations. The method comprises receiving, by a travel provider processing system under control of a travel provider, information from a traveler during a ticketing or reservation process. The method also includes sharing with a credit card approval and issuance system working under control of a credit card issuer, the information from the traveler collected during a ticketing and reservation process. In addition, the method includes determining by the credit card issuer that the traveler is eligible to receive an offer for a credit card. Further, the travel provider offers a credit card to the traveler.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a schematic representation of the present system.

### DETAILED DESCRIPTION OF THE INVENTION

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

The present system for credit issuance 10 provides an automated credit evaluation and credit approval system, and a card issuing system and method integrated with travel provider ticketing and reservations. As will be explained below in greater detail, the method is implemented by integrating the information collected during the travel provider ticketing and reservations process with a credit card issuing services to determine credit worthiness and to provide pre-approval of a borrowing instrument such as a credit card.

As will be explained below this is achieved by receiving, by a travel provider processing system under control of a travel provider, information from a traveler during a ticketing or reservation process. Thereafter, the travel provider shares, with a credit card approval and issuance system working under control of a credit card issuer, the information from the traveler collected during a ticketing and reservation process. In addition, the method includes determining by the credit card issuer that the traveler is eligible to receive an offer for a credit card. Finally, the travel provider offers a credit card to the traveler.

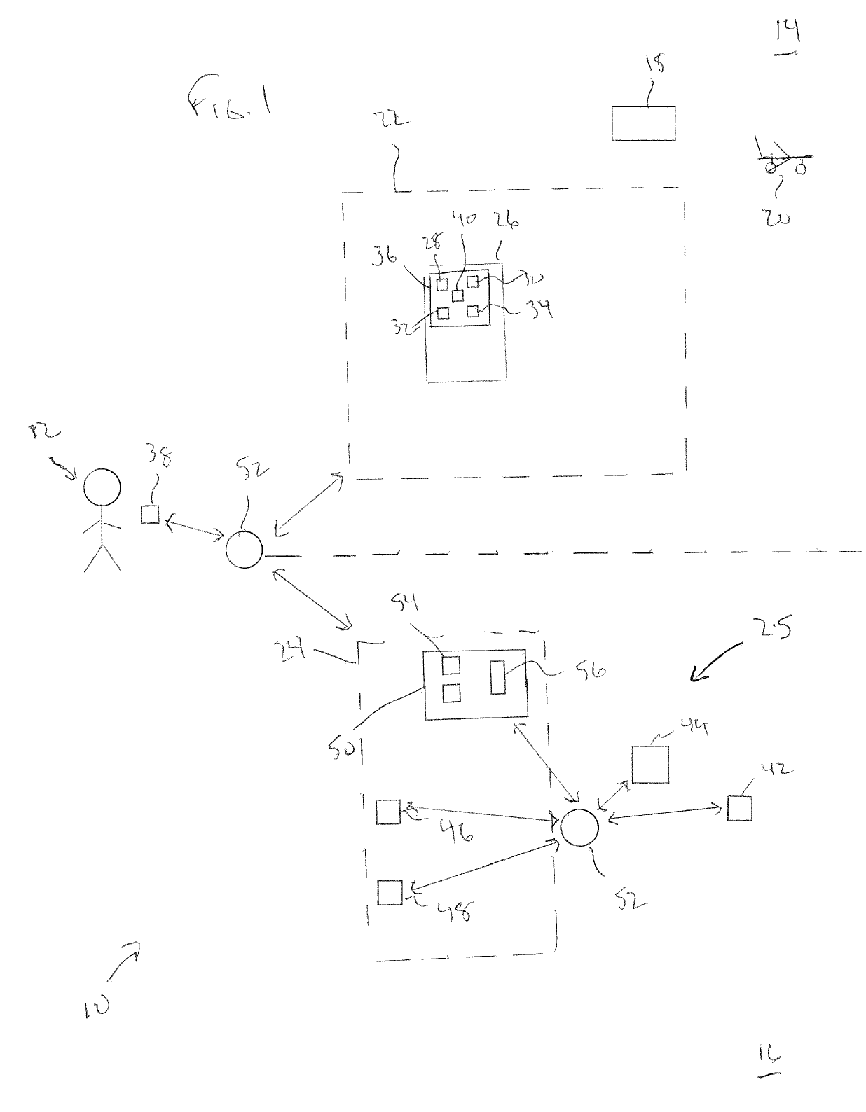

Referring to FIG. 1, the main components of the present system for credit issuance 10 are disclosed. The disclosed system for credit issuance 10 provides a coordinated system allowing for travel providers (for example, airlines) and credit card issuers to offer promotions in conjunction with the issuance of credit cards. As such, the present system for credit issuance 10 coordinates the functionalities offered by a travel provider with those offered by a credit card issuer to provide valuable services and enhancements to travelers booking flights and traveling based upon those booked flights.

Once a traveler 12 books a ticket, the information collected during the ticketing process is shared by the travel provider 14 with the partner credit card issuer 16 of the travel provider 14. With this information in hand, a determination is made by the credit card issuer 16 that the traveler 12 is eligible to receive an offer for a credit card. When the traveler (or customer) 12 receives an email reminder to check-in for their flight, it is accompanied by a pre-approved offer for a credit card issued by credit card issuer 16 of the travel provider 14. In the alternative, and as will be appreciated based upon the following detailed disclosure, the traveler 12 can receive the offer at the time of check in in the airport (or travel) terminal 18 or on when the traveler 12 is actually on the aircraft (or travel vehicle) 20 for the flight itself. The offer indicates that if the traveler 12 applies (and is approved) they will be able to pick up the credit card at a designated location at the airport terminal 18, either before they have boarded the flight or after they deplane, depending on when they received the offer.

With this in mind, the present system for credit issuance 10 includes and integrates an travel provider processing system 22, a credit card approval [A2] and issuance system 24 working in conjunction with a payment transaction service in a banking system 25, and a plurality of travelers 12 wishing to take advantage of flights, promotions and convenient credit card issuance. All of these communicate via a data network, for example, the Internet or other private network.

It is appreciated that a traditional travel provider processing system 22 includes a travel provider reservation system 26 composed of travel provider schedules 28, passenger reservations 30 and ticket records 32. The travel provider reservation system 26 also maintains an inventory of available seats 34 on the various flights scheduled in the future. The inventory of available seats 34 is divided into various service classes (e.g. first, business or economy class) for which different prices and booking conditions apply. These records are maintained in a travel provider database 36 that is accessed as reservations are made, processed and ultimately used when a traveler checks-in, receives a boarding pass and boards the flight.

While some travelers communicate with travel providers 14 directly via landlines or direct person to person communication, the vast majority of travelers communicate with travel providers via a global communication network, for example, the Internet using various forms of computers 38 (for example, laptops, desktops, tablets, smartphones, and other computer based communication device which allow for access with the travel provider processing system either directly or via the global communication network). Travelers commonly access the travel provider reservation system 26 through a graphical user interface providing travelers with available flights for a particular city and the available seats within desired booking classes. The travel provider reservation system 26 also provides fares and may other alternate fares where cheaper flights are desired. Once a decision is made, the traveler 12 may purchase desired tickets and provide relevant information for maintenance within the travel provider database 36. With this in mind, the travel provider database 36 maintains a wealth of knowledge regarding both the services being offered by a travel provider 14 as well as those travelers 12 planning trips on the travel providers.

In particular, the passenger name records 40 maintained upon the travel providers database contains personal information such as name, contact information or special services requests. The passenger name records 40 also includes the flights segments associated with all travelers, and may also include information regarding the manner in which the traveler 12 paid for the ticket, the traveler's social security number, credit history and rating.

Considering now the issuance, authentication and use of credit cards, it is appreciated various names may be applied in designating the parties of a transaction, and those using the present system. In accordance with the present description, the term “merchant” is used to describe the receiver of payment, for example, for goods or services, and “customer” is used to describe the provider of payment. A conventional card payment system is made up of a number of components: cardholder (the traveler 12 in accordance with the present scenario), merchant 42, merchant acquirer 44, payment scheme 46 and credit card issuer 16. As is appreciated by those skilled in the art, the cardholder is the consumer 12 purchasing goods or services with a card, the merchant 42 is selling the goods or services to the consumer 12, the merchant acquirer 44 is an intermediary that functions to process the transaction on behalf of the merchant 42 and credit card issuer 16, the payment scheme 46 refers to the entity operating a specific transaction protocol (i.e., rules for the interchange) in which the cardholder 12, merchant 42, merchant acquirer 44 and credit card issuer 16 have agreed to participate, and the credit card issuer 16 is the bank or other entity offering the cards directly to the consumer 12 and ultimately assuming financial liability for the transaction by providing the cardholder 12 with a line of credit.

By way of background, and as is readily appreciated, in the normal process the cardholder 12 presents his card (or payment token) to the merchant 42 in order to pay for goods or services rendered; this transaction may take place over any one of a number of channels (in store or via the Internet, for example). The merchant 42, through his merchant acquirer 44, is set up to accept different card types by scheme (Visa®, MasterCard®, Amex®, credit, debit, for example). When a card is presented, the cardholder 12 is authenticated (by Personal Identification Number, PIN, passcode, or Card Verification Value, CV2, for example), subject to channel and merchant capability, and the transaction is submitted to the merchant's acquirer 44 (referred to herein as “merchant acquirer”) for authorization.

Once the transaction is received, the merchant acquirer 44 routes the authorization transaction, in real time, to the relevant payment scheme 46 based upon card type. The payment scheme 46 provides isolation between merchant acquirers 44 and credit card issuers 16 for routing of authorizations, settlements and funds movement. The merchant acquirer 44 doesn't need to know who the credit card issuer 16 is, just which payment scheme 46 to route it to which is determined by Bank Identification Number (BIN). The credit card issuer 16 authorizes the transaction based upon the cardholder's balance and other risk/fraud criteria and returns an authorized message and authorization code to the payment scheme 46, which routes it back to the merchant acquirer 44 who sent it to the merchant 42. The merchant 42 then confirms the sale, which posts a settlement transaction to the merchant acquirer 44; this is a mandate to make the payment and move funds. The settlement transaction is routed between merchant acquirers 44 and card issuers via the payment scheme 46.

Prior to permitting transactions as described above, the consumer 12 (or traveler in the present scenario) must be approved for the issuance of a credit card. Such a credit card authentication and issuance system 24 includes a computer-implemented method of processing enrollment of a user for a payment transaction service in a banking system 25. As will be appreciated based upon the following disclosure, credit card authentication and issuance system 24 uses the information gathered by the travel provider processing system 22 to authenticate and issue credit cards. Traveler data gathered during the ticketing process is retrieved to populate an authentication and issuance form for registering the traveler to initiate the authentication and issuance of a credit card for offering to the traveler 12 when he or she arrive at the airport.

With this in mind, the credit card authentication and issuance system 24 includes an authentication system 50, the payment scheme 46 and the credit card issuer, all connected via a data network 52. The data network 52 may be any suitable data communication network such as a wireless network, a local- or wide-area network including a corporate intranet or the Internet, using for example the TCP/IP protocol, or a cellular communication network such as GPRS, EDGE or 3G, for example. Such communication protocols are of a type that are known per se in data networks and need not be described further. The authentication system 50, the payment scheme 46 and the credit card issuer 16 function in conjunction to issue credit cards and to authorize and settle credit card transactions. It is appreciated the authentication system may be owned by the credit card issuer or simply contracted to work on behalf of the credit card issuer.

The authentication system 50 includes a registration module 54 for processing registration of the travelers to ultimately issue credit cards in accordance with the present invention. Additionally, the authentication system stores information associated with registered cardholders in a credit database 56. In practice, the registration module 54 of the authentication system 50 receives the data relating to a traveler from the travel provider processing system 22 (preferably via a data network 52) and verifies the input data to determine the appropriateness of issuing a credit card to the traveler. It will be appreciated that the registration decision process may involve additional processing steps before registration is approved or declined, such as carrying out a series of additional checks, including credit bureau checks and payment scheme checks (e.g. Visa/MasterCard) as are known per se.

Thereafter, the credit card authentication and issuance system 24 transmits data indicative of authorization to the travel provider processing system 22 for inclusion of an offer with the email reminding the traveler 12 to check in for travel. In particular, the disclosed system for credit issuance 10 is utilized in providing travelers 12 with offers of access to pre-approved credit and other promotions with a customer booking a ticket with a travel provider partner. When this occurs, the data collected during the ticketing process is stored in the travel provider database 36 providing the travel provider, and ultimately the credit card issuer 16, with detailed traveler information. The traveler information is then shared with the partner credit card issuer 16 which evaluates such information using the authentication system 50 (in particular, the authentication module 58 thereof) to evaluate the collected data for determining the appropriateness of preapproving the traveler 12 for a credit card. If the traveler 12 is credit worthy or eligible to receive a pre-approved credit card offer from the credit card issuer 16 of the travel provider 14, the credit card authentication and issuance system 24 informs the travel provider 14 of the traveler's credit worthiness.

With this information in hand, the travel provider processing system 22 issues an email reminder to the traveler 12 reminding the traveler 12 to check-in for an upcoming flight and includes with the reminder a pre-approved offer for a new travel provider credit card provided by the credit card issuer 16. This email can be sent at any time before travel is undertaken. The pre-approved offer states that the traveler 12 can apply for a card immediately and if approved they can pick up the card at the airport terminal 18. If the traveler 12 accepts the offer, they receive an at least partially prepopulated application which they can send for an instantaneous decision as to whether they will receive a card. The application goes to the registration module 54 and authentication module 58 of the authentication system 50 of credit card issuing 48 for a final evaluation of creditworthiness by the authentication system 50 of the credit card issuer 16.

If approved the traveler 12 is offered at least one of the following immediate benefits for their current flight travel. They can be offered that their bags fly free on this trip, or they can be offered to go thru Expedited Security Lines, they can board with priority, they can visit the exclusive Club of the travel provider partner, or they can receive a neck pillow at the airport terminal 18 prior to boarding.

When the customer clicks on “APPLY NOW” in email, the traveler 12 is directed to a web page of the credit authorizing and issuance system 24 of the credit card issuer 16 where the traveler 12 is provided with a pre-populated application. The traveler 12 will be asked to provide a few more pieces of information. The complete application is submitted to the registration module 54 and authentication module 58 of the authentication system 50 and the traveler 12 thereafter receives an immediate decision on approval.

When the traveler 12 arrives at the airport terminal 18 and proceeds to a designated counter or area and they are greeted with the new card, neck pillow, & boarding passes. Alternatively, or in addition their check in bags fly for free (No fees to check your bags on the departure or return flights). Further, the traveler 12 breezes right through security with printed (or mobile) boarding pass and they can proceed through the Preferred Security Line. The traveler 12 also has the opportunity to relax at the travel provider partner Club.

Alternatively, the traveler 12 arrives at the airport terminal 18 to check into the flight and at the time of check-in they receive a boarding pass with a pre-approved offer for the new travel provider partner credit card, which has an unique QR code so that the traveler 12 can scan the offer with his/her mobile device 38 and apply in the airport terminal for a card. As indicated above, if the traveler 12 accepts the offer, the traveler 12 is directed to a web page of the credit authorizing and issuance system 24 of the credit card issuer 16 where the traveler 12 is provided with a pre-populated application. The traveler 12 will be asked to provide a few more pieces of information. The complete application is submitted to the registration module 54 and authentication module 58 of the authentication system 50 and the traveler 12 thereafter receives an immediate decision on approval. If approved the traveler 12 is then offered at least one of the following immediate benefits for their current flight travel. They can be offered that their bags fly free on this trip, or they can be offered to go thru Expedited Security Lines, they can board with priority, they can visit the exclusive Club of the travel provider partner, or they can receive a neck pillow at the airport prior to boarding.

In the next alternative embodiment of the invention, the traveler 12 boards the flight from and listens to the Flight Attendant's announcement about the new travel provider partner credit card and its current availability. The offer indicates that if the traveler 12 applies on the flight & if they are approved they will be issued a card at the destination airport upon arrival. Further, since they were approved they are entitled to various immediate benefits on the current flight, namely they can use free Wi-Fi today while in flight. Once the card is picked up at the destination airport terminal 18 location the traveler 12 is informed that they will receive various benefits on their next flight, namely their bags fly free on your next trip, they can go thru expedited security lines, they can board with priority, visit the travel providers exclusive club, receive a neck pillow, and receive an additional 500 bonus miles, or the like if they apply in flight with a special promo code (which is this Flight Attendant's employee identifier).

Alternatively, they may already have been pre-approved for this offer and they go online and see the offer in a banner ad on the airplane Wi-Fi homepage. Once the traveler 12 enters his/her name & travel provider rewards number, he/she is happy to see that she has already been provisionally pre-approved. The customer applies and is then formally approved and the customer mentions his/her new card to the Flight Attendant, who welcomes the card member and gives him/her a neck pillow

As the customer de-planes, he/she picks up his/her new plastic at the travel provider credit card store at the airport.

While the preferred embodiments have been shown and described, it will be understood that there is no intent to limit the invention by such disclosure, but rather, is intended to cover all modifications and alternate constructions falling within the spirit and scope of the invention.

1. A system for credit issuance provides for automated credit evaluation and for card issuing integrated with travel provider ticketing and reservations, the system comprises:
a travel provider processing system under control of a travel provider;
a credit card approval and issuance system working under control of a credit card issuer in conjunction with a payment transaction service in a banking system; and
a plurality of travelers;
wherein once a traveler books a ticket, information collected during a ticketing process is shared by a travel provider with the credit card issuer, and with the information a determination is made by the credit card issuer that the traveler is eligible to receive an offer for a credit card.

2. The system for credit issuance according to claim 1, wherein the traveler receives an email reminder from the travel provider processing system to check-in for travel, and the email reminder is accompanied by a pre-approved offer for a credit card issued by the credit card issuer.

3. The system for credit issuance according to claim 1, wherein the traveler is provided a pre-approved offer at a travel terminal for a credit card issued by the credit card issuer.

4. The system for credit issuance according to claim 1, wherein the traveler is provided a pre-approved offer on a travel vehicle for a credit card issued by the credit card issuer.

5. The system for credit issuance according to claim 1, wherein the travel provider processing system includes a travel provider reservation system composed of travel provider schedules, passenger reservations and ticket records maintained in a travel provider database.

6. The system for credit issuance according to claim 5, wherein passenger name records are maintained upon the travel provider database.

7. The system for credit issuance according to claim 1, wherein the credit card approval and issuance system includes an authentication system, a payment scheme and the credit card issuer all connected via a data network.

8. The system for credit issuance according to claim 7, wherein the authentication system includes a registration module for processing registration of travelers to ultimately issue credit cards.

9. The system for credit issuance according to claim 1, wherein the traveler is provided with a promotion in exchange for the applying for the credit card.

10. A method for credit issuance providing for automated credit evaluation and for card issuing integrated with travel provider ticketing and reservations, the method comprises the steps of:
receiving, by a travel provider processing system under control of a travel provider, information from a traveler during a ticketing or reservation process;
sharing, with a credit card approval and issuance system working under control of a credit card issuer, the information from the traveler collected during a ticketing and reservation process,
determining, by the credit card issuer that the traveler is eligible to receive an offer for a credit card, and
offering, by the travel provider, a credit card to the traveler.

11. The method for credit issuance according to claim 10, wherein the offering includes the traveler receiving an email reminder from the travel provider to check-in for travel, and the email reminder is accompanied by a pre-approved offer for the credit card issued by the credit card issuer.

12. The method for credit issuance according to claim 10, wherein the offering includes providing a pre-approved offer at a travel terminal for a credit card issued by the credit card issuer.

13. The method for credit issuance according to claim 10, wherein the offering includes providing a pre-approved offer on a travel vehicle for the credit card issued by the credit card issuer.

14. The method for credit issuance according to claim 10, wherein the travel provider processing system includes a travel provider reservation system composed of travel provider schedules, passenger reservations and ticket records maintained in a travel provider database.

15. The method for credit issuance according to claim 14, wherein passenger name records are maintained upon the travel provider database.

16. The method for credit issuance according to claim 10, wherein the credit card approval and issuance system includes an authentication system, a payment scheme and the credit card issuer all connected via a data network.

17. The method for credit issuance according to claim 16, wherein the authentication system includes a registration module for processing registration of travelers to ultimately issue credit cards.

18. The method for credit issuance according to claim 10, further including the step of providing the traveler with a promotion in exchange for applying for the offer for the credit card.
